(19) United States
(12) Patent Application Publication
(10) Pub. No.: US 2026/0093031 A1
(43) Pub. Date: Apr. 2, 2026

(54) METHOD FOR DETERMINING ELECTROMAGNETIC PROPERTIES OF A NON-UNIFORM MEDIUM BY MEANS OF A RADIO-FREQUENCY DETECTION SYSTEM

(71) Applicant: COMMISSARIAT À L'ENERGIE ATOMIQUE ET AUX ENERGIES ALTERNATIVES, PARIS (FR)

(72) Inventors: Pascal PAGANI, GRENOBLE (FR); Jean-Baptiste DORE, GRENOBLE (FR); Raffaele D'ERRICO, GRENOBLE (FR)

(21) Appl. No.: 19/343,548

(22) Filed: Sep. 29, 2025

(30) Foreign Application Priority Data
Oct. 2, 2024 (FR) 2410588

(51) Int. Cl. G01S 13/88

(52) U.S. Cl. CPC G01S 13/885

(57) ABSTRACT

A method for determining electromagnetic properties of a non-uniform medium by a radio-frequency detection system. The method includes: determining a measurement of a frequency transfer function of a transmission channel characterizing the medium; determining a model of the frequency transfer function dependent on at least one positional variable and on at least one variable characterizing an electromagnetic property of the medium; determining a global estimation function estimating the correlation coefficient between the transfer function measurements and the models; searching for at least one local maximum of the estimation function in the domain defined by the at least one positional variable and the at least one variable characterizing an electromagnetic property of the medium; deducing therefrom at least one value of the variable characterizing the electromagnetic property of the medium as the one that makes it possible to obtain the local maximum.

### CROSS-REFERENCE TO RELATED APPLICATION

This application claims priority to foreign French patent application No. FR 2410588, filed on Oct. 2, 2024, the disclosure of which is incorporated by reference in its entirety.

### FIELD OF THE INVENTION

The invention relates to the field of non-destructive devices and methods for characterizing the composition of a material or non-uniform medium by means of a radio-frequency system. For example, the invention relates notably to ground-penetrating radars allowing underground targets to be detected, located or identified.

The invention may also relate to the field of health, characterization of biological tissues for example.

### BACKGROUND

More precisely, the invention relates to a method for determining electromagnetic properties of a non-uniform medium by means of a radio-frequency system.

In any application aiming to detect elements in a medium or material using a radio-frequency detection system, knowledge of the electromagnetic properties of the detection medium is important.

Specifically, the spatial location of sought targets is generally determined by analysing the propagation time of electromagnetic signals transmitted and received by the radio-frequency system, which are then converted into distances using an estimate of the propagation velocity of the electromagnetic waves through the medium. However, the propagation velocity of an electromagnetic wave depends on the electromagnetic properties of the medium, and in particular (although not exclusively) on its dielectric permittivity. The electromagnetic properties of the medium make it possible to describe the response of this medium to an applied electric field.

For example, in the case of ground-penetrating radars, the medium through which the electromagnetic waves pass is generally the ground. In the case of applications in the health field, the medium passed through is a set of biological tissues.

Most of the time, a priori assumptions are made regarding the actual values of the electromagnetic characteristics of the medium, such as its dielectric permittivity. However, the accuracy of these values may be important for obtaining sufficient accuracy in the detection and characterization of targets.

The invention therefore addresses a general problem of accurate characterization of the electromagnetic properties of a medium through which an electromagnetic wave propagates, in particular its dielectric permittivity or permeability.

In the field of ground-penetrating radars, there are a number of methods for detecting the position of a target.

One known prior-art method involves fitting hyperbolic curves, as for example described in reference [1]. When an antenna of the ground-penetrating radar is moved over the surface of the ground and the penetrating wave encounters buried targets or interfaces between various layers of the ground, the received signal observed in the time domain has a hyperbola shape, because of the propagation times of the reflected waves, which differ depending on the relative position of the target and the antennas of the radar. A number of configurations in respect of antenna positions may be used to observe this effect. For example, the transmit (Tx) and receive (Rx) antennas may make an identical movement, each thus remaining in a fixed position relative to the other. Alternatively, the Tx antenna may make a movement symmetrical to the movement of the Rx antenna, with respect to a fixed central point, this configuration then being called the “Common Mid Point” configuration. Lastly, one antenna may be placed in various positions with respect to a fixed second antenna, in a configuration called the “Wide Angle Reflection and Refraction” configuration.

All these observation techniques make it possible to obtain a hyperbola-shaped plot when observing the received signal in the time domain as a function of an antenna position metric. The peak of the hyperbola then indicates the actual position of the target (or interface) and the shape of the hyperbola depends on the horizontal spatial increment and on the velocity of the signal in the material: the higher the velocity, the wider the hyperbola and vice versa. By analysing the shape of the hyperbola, it is possible to determine the propagation velocity of the wave in the medium and thus determine the electrical permittivity of the medium. The observed signal is fitted to a theoretical hyperbola through semblance analysis, as described for example in references [2, 3].

This method is very commonly used to calibrate GPR data, but has a number of major drawbacks. The accuracy of the method remains low due to the difficulty of fitting a theoretical curve to an experimental observation marred by uncertainty. To increase accuracy a higher number of observations must be made, this potentially requiring the antennas to be moved for each observation. Antenna movement may be avoided if multiple, spatially distributed Tx and Rx antennas are available, but in this case the accuracy of the fitting technique is low. The method is also not well suited to detection of stratified layers in a non-uniform medium, because the various reflections produce hyperbolas that overlap, making fitting more difficult. This situation requires complex algorithms to be implemented, as illustrated in reference [4].

Another type of known method relates to migration methods, as for example described in reference [5]. These methods seek to reduce the inaccuracy in the hyperbola-fitting method due to observational uncertainties in the received signal. It is a form of mathematical processing, the main aim of which is to increase the accuracy of hyperbolic plots of targets and interfaces. Theoretically, this process makes it possible to reduce the hyperbolas acquired by the radar to a single location point. However, the implementation of this technique is difficult when applied to potentially noisy experimental data. There are a wide variety of different migration methods including hyperbolic summation, Kirchhoff's migration, back-projection focusing, phase shift migration, and ω-k migration [5].

The main parameter required to reduce a hyperbola to a point corresponds to the dielectric properties of the ground, as taught in reference [6]. This makes the migration process a way of increasing the accuracy of the fit to the curve since the process only works properly if the applied transmission velocity through the ground is accurate. Thus, migration methods use an average estimate of the relative permittivity of a material for a given depth. One drawback of these methods is their relative inaccuracy when the material is made up of a plurality of layers of different permittivities.

Reference [6]proposes a method applied to the detection of buried targets. It proposes testing different values of average permittivities for a given acquisition. The selected permittivity is the one that minimizes the area of the detected target. Therefore, this method is not generic and is not applicable in the absence of a target, for example in the case of a stratified non-uniform material. Moreover, the metric of the apparent area of the target is inexact and is suitable only for targets of simple shape, the apparent area of which varies monotonically with the absolute error in the assumed permittivity.

Other known methods aim to solve the problem of determining the electromagnetic properties of a medium using a radio-frequency detection system. Mention may notably be made of the following patents and patent applications: WO2020180191, EP3164672, WO2022091456, FR3041108 and FR3142553.

All these methods have drawbacks, some are invasive and destructive, others require prior knowledge of the geometry of the medium, and yet others are not applicable to a non-uniform medium. Generally, these methods provide ways of processing radar data in the time domain.

There is a need for a method for accurately characterizing the electromagnetic properties of a medium, by means of a radio-frequency detection system, that overcomes the limitations of prior-art methods. In particular, the proposed method must be of low complexity in order to be compatible with implementation in an embedded system with limited resources.

A new characterizing method is provided that operates in the frequency domain and that has a lower complexity than the prior-art methods.

### SUMMARY OF THE INVENTION

One subject of the invention is a method for determining electromagnetic properties of a medium, comprising steps of:
determining, by means of a radio-frequency detection system comprising at least one transmitter and one receiver, for each pair associating one receiver and one transmitter, a measurement of a frequency transfer function of a transmission channel characterizing said medium,
determining, for each of said pairs, a model of said frequency transfer function dependent on at least one positional variable and on at least one variable characterizing an electromagnetic property of the medium,
determining, for each of said pairs, a correlation coefficient between the measurement of the frequency transfer function and the model,
determining a global estimation function estimating the correlation coefficient between the transfer function measurements and the models, for all pairs,
searching for at least one local maximum of the estimation function in the domain defined by the at least one positional variable and the at least one variable characterizing an electromagnetic property of the medium,
deducing therefrom at least one value of the variable characterizing the electromagnetic property of the medium as the one that makes it possible to obtain said local maximum.

According to one particular aspect of the invention, the step of searching for at least one local maximum of the estimation function is carried out by means of multiple iterations of substeps of:
defining a first sampling level of the search space,
searching for a local maximum for this first sampling level,
reducing the search space around the local maximum and defining a second sampling level in the reduced search space, the step of the second sampling level being finer than the step of the first sampling level.

According to one particular aspect of the invention, the step of searching for at least one local maximum of the estimation function comprises substeps of:
searching for a first local maximum of the estimation function,
determining the backscatter coefficient of the first scatterer associated with the first local maximum from said local maximum of the global estimation function,
determining the contribution of the first scatterer to the measurement of the frequency transfer function as equal to the product of the backscatter coefficient of the first scatterer and the value of the transfer function model taken at the coordinates of the first local maximum,
subtracting the contribution of the first scatterer from the measurement of the frequency transfer function,
iterating the preceding steps to search for another local maximum of the global estimation function determined from the corrected measurement of the frequency transfer function.

According to one particular aspect of the invention, the at least one variable characterizing an electromagnetic property of the medium is selected from: the real part or imaginary part of the dielectric permittivity or permeability.

In one variant embodiment, the method comprises searching for multiple local maxima of the estimation function, each local maximum providing a position value for a scatterer of the medium and a value of the variable characterizing the electromagnetic property at said position.

According to one particular aspect of the invention, the correlation coefficient is determined using a ZF, MMSE or MRC equalization method.

According to one particular aspect of the invention, the global estimation function estimating the correlation coefficient is determined as an average of the correlation coefficients for all the pairs and for one or more discrete frequency values.

According to one particular aspect of the invention, each correlation coefficient is weighted by a predefined weighting coefficient.

According to one particular aspect of the invention, the at least one positional variable is a depth value and the method comprises a step of replacing, in the global estimation function, the depth variable with an electrical depth variable zₑₗ=z·\sqrt{εᵣ′}, where ε′ᵣ is the real part of the dielectric permittivity.

Another subject of the invention is a system for determining electromagnetic properties of a medium comprising a radio-frequency detection device comprising at least one transmitter and one receiver and a processing unit, the system being configured to implement the method according to the invention.

According to one particular aspect of the invention, the radio-frequency detection system is a ground-penetrating radar.

Other subjects of the invention are a computer program comprising code instructions that cause the device according to the invention to execute the steps of the method according to the invention and a computer-readable medium on which the computer program according to the invention is stored.

### BRIEF DESCRIPTION OF THE DRAWINGS

Other features and advantages of the present invention will become more clearly apparent on reading the following description, with reference to the following appended drawings.

FIG. 1 shows a flowchart detailing the steps of implementation of a method for determining electromagnetic properties of a medium according to one embodiment of the invention,

FIG. 2 schematically shows one example of a radio-frequency detection system capable of implementing the invention,

FIG. 3 illustrates a graphical representation of a transfer function model,

FIG. 4 shows a flowchart detailing the steps of a first variant embodiment of the method according to the invention,

FIG. 5 illustrates an application of the variant of FIG. 4,

FIG. 6 shows a flowchart detailing the steps of a second variant embodiment of the method according to the invention,

FIG. 7a shows an illustration of the estimation of permittivity obtained by focusing in the (ε′ᵣ, z) domain,

FIG. 7b shows an illustration of the estimation of permittivity obtained by focusing in the (ε′ᵣ, zₑₗ) domain,

FIG. 8 schematically shows one example of a system capable of implementing the invention.

### DETAILED DESCRIPTION

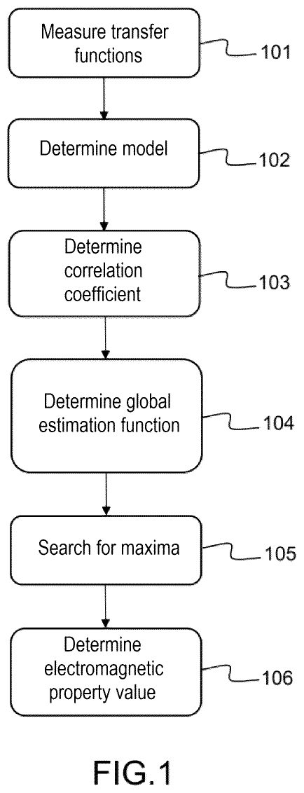

FIG. 1 shows a flowchart of a method for determining electromagnetic properties of a medium according to one embodiment of the invention.

In the remainder of the description, the method will be described in the context of a non-limiting example intended to determine the permittivity of a medium such as the ground by means of a radio-frequency detection system such as a ground-penetrating radar. However, the invention is not limited to determination of permittivity but extends to determination of any electromagnetic property characterizing a medium, such as also permeability.

Likewise, the invention is not limited to the use of a ground-penetrating radar device but extends to any radio-frequency detection device.

The method starts in step 101 with a set of measurements of frequency transfer functions by means of a radio-frequency detection device.

The radio-frequency detection system is made up of a transmitter capable of transmitting a radio-frequency signal via at least one Tx transmit antenna and of a receiver capable of receiving this radio-frequency signal via at least one Rx receive antenna. A number of versions of the transmitted signal are observed and depend on the positions of the Tx antenna and the Rx antenna.

According to one variant embodiment, these various versions of the received signal are obtained from a plurality of Tx antennas located at fixed positions and a plurality of Rx antennas located at fixed positions, in a configuration of the radio-frequency detection device called the MIMO configuration, MIMO standing for “Multiple Input Multiple Output”.

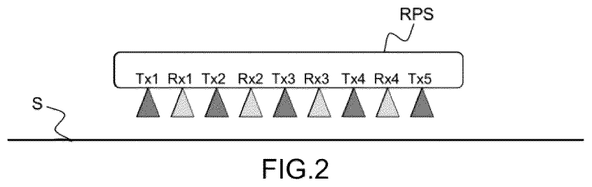

FIG. 2 schematically shows one example of such a radio-frequency detection system taking the form of a ground-penetrating radar (GPR) having five transmit antennas and four receive antennas.

Alternatively, the various measurements may also be obtained by carrying out successive transmissions, and by moving the Tx or Rx antennas between each transmission.

Thus, one measurement is obtained for each pair associating one Tx transmit antenna with one Rx receive antenna for a given position of these two antennas.

The invention is also applicable to the case where a single antenna serves both for transmission and reception and is connected to the transmitter and receiver by way of a separating device such as a coupler.

The signals transmitted via each pair of Tx and Rx antennas are separated in the time domain through successive transmissions, but they may also be separated using any conventional multiple-access method, such as frequency- or code-based separation.

The general case of a system made up of M transmit antennas and N receive antennas or more generally M different transmit antenna positions and N different receive antenna positions will now be considered. M and N are two strictly positive integers.

The radio-frequency detection system further comprises an estimation module configured to determine, from the signal transmitted via the Tx antenna in position m and received via the Rx antenna in position n, a complex transfer function Hₘₙ(f) for various frequency values f.

A number of methods for obtaining the transfer function Hₘₙ(f) and for choosing a signal to be transmitted exist in the prior art and are techniques known in the field of channel estimation or radio sounding. References [9], [10] and [11] give examples of such methods.

The transfer function Hₘₙ(f) depends on the composition of the medium through which the signal passes, and in particular on the spatial distribution of the electromagnetic properties of the medium, and in the case of the presence of targets, on the position and radar cross section (RCS) of the targets.

At the end of step 101, one measurement of the transfer function Hₘₙ(f) is therefore obtained for a plurality of frequency values and for each pair (m,n) associating one transmit antenna and one receive antenna for which a measurement was taken.

Step 102 then comprises determining a theoretical model of the frequency transfer function that takes into account the electromagnetic properties of the medium through which the signal passes.

For example, the chosen model is suitable for a point scatterer located at a position rₚ in a non-uniform medium with a permittivity of real part ε′ᵣ and of negligible imaginary part. The transfer function between transmitter m and receiver n is modelled by the following equation, Equation (1):

$${W}_{mn} ( f ) = \frac{\sqrt{{G}_{m} {G}_{n}} \cdot c}{f \cdot ‖ {r}_{p} - {r}_{m} ‖ \cdot ‖ {r}_{n} - {r}_{p} ‖ \cdot {( 4 π )}^{3 / 2} \cdot \sqrt{{{ε}^{′}}_{r}}} \cdot {e}^{- i 2 π f \frac{\sqrt{{{ε}^{′}}_{r}}}{c} ( ‖ {r}_{p} - {r}_{m} ‖ + ‖ {r}_{n} - {r}_{p} ‖ )} \qquad ( 1 )$$

where rₘ and rₙ are the positions of the transmit antenna and receive antenna, respectively;
Gₘ and Gₙ are the respective gains of the transmit and receive antennas;
c is the speed of light in vacuum.

The model given by Equation (1) considers on the one hand the phase shift related to the geometry of the scene in the case of rectilinear propagation, and on the other hand an amplitude given by a radar equation taken from the literature (see reference [7]).

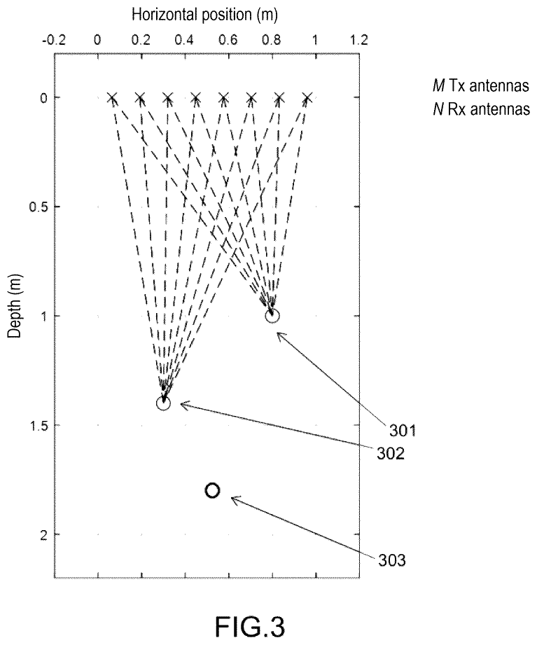

FIG. 3 schematically shows a graphical representation of the model of Equation (1) for M=N=8 and for two scatterers 301, 302. Reference 303 designates a test point located at the coordinates (x,z).

Without departing from the scope of the invention, other models may be developed to replace the one of Equation (1) provided that they take into account at least one electromagnetic property of the medium, for example the permittivity ε′ᵣ.

For example, Equation (1) may be replaced by the following Equation (1a) in which the coefficient \sqrt{E′ᵣ} is replaced by ε′ᵣ.

$${W}_{mn} ( f ) = \frac{\sqrt{{G}_{m} {G}_{n}} \cdot c}{f \cdot ‖ {r}_{p} - {r}_{m} ‖ \cdot ‖ {r}_{n} - {r}_{p} ‖ \cdot {( 4 π )}^{3 / 2} \cdot \sqrt{{{ε}^{′}}_{r}}} \cdot {e}^{- i 2 π f \frac{\sqrt{{{ε}^{′}}_{r}}}{c} ( ‖ {r}_{p} - {r}_{m} ‖ + ‖ {r}_{n} - {r}_{p} ‖ )} \qquad ( 1 a )$$

Specifically, Equation (1) provides a transfer function model suitable for a point scatterer located at a position rₚ in a uniform medium the permittivity of which has a real part ε′ᵣ and a negligible imaginary part. Its phase is calculated by considering the delay accumulated by the wave in the case of rectilinear propagation between the Tx antenna and the scatterer, then between the scatterer and the Rx antenna. Its amplitude is provided by the radar equation (see reference [7]).

Observation of experimental results seems to show that the model given by Equation (1) does not always model amplitude optimally.

A physical explanation in respect of the modification proposed in Equation (1a) is that radar cross section (RCS) is assumed to be independent of the electromagnetic properties of the medium. However, it is believed that the RCS of a given object varies in a manner inversely proportional to the permittivity ε′ᵣ of the medium.

The model of Equation (1a) allows better focusing, as explained below.

Step 103 comprises determining a correlation coefficient between the measurement made in step 101 and the model determined in step 102, for each pair of antennas.

For example, the correlation coefficient is determined by means of Relationship (2) which represents ZF equalization, ZF standing for Zero Forcing.

$${ℒ}_{mn} ( f , {r}_{p} , {ε}_{r}^{′} ) = \frac{{H}_{mn} ( f ) \cdot {W}_{mn}^{*} ( f , {r}_{p} , {ε}_{r}^{′} )}{{\vert {W}_{mn} ( f , {r}_{p} , {ε}_{r}^{′} ) \vert}^{2}} \qquad ( 2 )$$

where * represents complex conjugation.

Alternatively, the correlation coefficient may be obtained using another type of equalization, such as those of the MMSE or MRC type, MMSE and MRC standing for Minimum Mean Square Error and Maximum Ratio Combining, respectively.

The correlation coefficient depends at least on frequency, on at least one spatial coordinate and on at least one electromagnetic property, and is representative of a correlation between the measured transfer function Hₘₙ(f) and the model Wₘₙ (f, rₚ, ε′ᵣ).

Steps 101, 102, 103 are iterated for each pair associating one transmit antenna of index m and one receive antenna of index n.

Step 104 then comprises determining a global estimation function estimating the correlation coefficient for all the observations made by the radio-frequency detection system.

Given that the transfer functions are observed over a set of L discrete frequencies fₗ, and for the various bistatic angles between M transmitter positions lₘ and N receiver positions rₙ, the global estimation function is obtained by taking a coherent sum of the various observations, such as represented by Equation (3):

$$ℒ ( {r}_{p} , {ε}_{r}^{′} ) = \frac{1}{MNL} {\sum }_{m = 1}^{M} {\sum }_{n = 1}^{N} {ℒ}_{mn} ( {f}_{l} , {r}_{p} , {ε}_{r}^{′} ) \qquad ( 3 )$$

Step 105 then comprises searching for at least one maximum of the global estimation function, or more precisely of its absolute value when this function is complex. The search is carried out in the multidimensional space consisting of the spatial variables and of the variables characterizing the electromagnetic properties forming the domain of definition of this function.

This approach is based on the principle that the values of the electromagnetic properties that best correspond to the physical reality of the actual, real region of ground in question will result in values of the correlation coefficient that are consistent between the various frequencies and various observation configurations, maximizing the modulus of the coherent sum of Equation (3).

This principle of maximization of the modulus of the coherent sum of the correlation coefficients for values of variables that correspond to an observed physical reality is also called “focusing”.

Step 106 of the method comprises deducing the value of at least one electromagnetic property associated with a spatial position.

For example, in the case of the example of Equations (2) and (3), a position value

$${r}_{p}^{max}$$

and a dielectric permittivity value

$${ε}_{r}^{′ max}$$

associated with this position are obtained, these values being defined by Equation (4):

$$( {r}_{p}^{max} , {ε}_{r}^{′ max} ) = {arg max}_{{r}_{p} , {ε}_{r}^{′}} \vert x ( {r}_{p} , {ε}_{r}^{′} ) \vert \qquad ( 4 )$$

where argmax is the mathematical function argument of the maximum, which delivers the values of the variables for which a function reaches its maximum.

Given the predefined model expressed by Equation (1), the vector

$${r}_{p}^{max}$$

teaches the position of the point scatterer delivering the largest radar cross section in the observed space and

$${ε}_{r}^{′ max}$$

teaches the most representative value of the real part of the average dielectric permittivity in the part of the medium through which the electromagnetic wave passes between the transmit antennas and the receive antennas via the position

$${r}_{p}^{max} .$$

Advantageously, step 106 is not limited to a search for a single maximum, but may be extended to a search for a plurality of local maxima of the function | [symbol] (rₚ, ε′ᵣ)|.

For example, the R peaks of the continuous function | [symbol] (rₚ, ε′ᵣ)| having the highest values are sought. The coordinates of each local maximum deliver both the spatial position of a substantial scatterer and the value of the electromagnetic property most representative of the medium through which the electromagnetic wave passes between the transmit antennas and the receive antennas via this scatterer.

In one variant embodiment of the invention, the search for the maximum (step 105) may be carried out in a subdomain of the domain of definition of the function | [symbol] (rₚ, ε′ᵣ)|. Thus, for example, the search for the maximum may be limited to a subset of given spatial positions, for example points located beyond a certain depth in the case of a ground-penetrating radar. Likewise, the search for the values of electromagnetic properties may be limited to a predefined interval.

In another variant embodiment of the invention, the global estimation function given by Equation (3) is modified by assigning a variable weight to each correlation coefficient. Equation (3) then becomes:

$$ℒ ( {r}_{p} , {ε}_{r}^{′} ) = \frac{1}{MNL} {\sum }_{m = 1}^{M} {\sum }_{n = 1}^{N} {\sum }_{l = 1}^{L} γ ( m , n , l ) \cdot {ℒ}_{mn} ( {f}_{l} , {r}_{p} , {ε}_{r}^{′} ) \qquad ( 5 )$$

γ(m,n, l) is a weighting coefficient that may take different values for each observation associated with a frequency and a pair of antennas.

For example, the following weighting function makes it possible to disregard observations made by the transmit antenna of index m=1, in the case where these observations are judged erroneous:

$$γ ( m , n , l ) = 0 , if m = 1$$

$$γ ( m , n , l ) = 1 , if m \neq 1$$

To implement the method described in FIG. 1, one difficulty lies in exploring the domain of definition of the function | [symbol] (rₚ, ε′ᵣ)|. Indeed, depending on the number of spatial variables and electromagnetic parameters that form the dimensions of this domain, the search for a maximum may become very complex, and require a significant execution time that may be incompatible with a real-time implementation in an embedded device with limited resources.

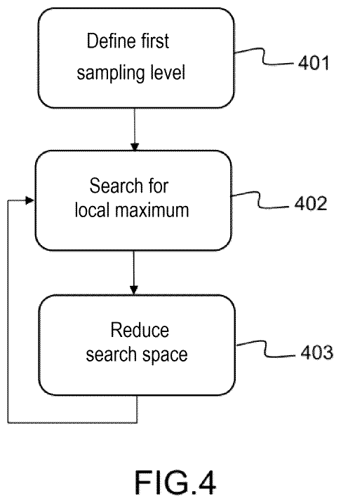

To overcome this drawback, a first variant embodiment of the invention is proposed, described in FIG. 4, which aims to optimize the exploration space of the global estimation function. In other words, this involves optimizing step 105 of searching for local maxima.

The flowchart of FIG. 4 details the steps for implementing this variant embodiment of step 105.

Step 401 comprises determining a first sampling level, called rough sampling level, of the exploration space having a predefined sampling step so as to have a limited number of samples in the exploration space, this number being compatible with the memory space and computing power available.

Step 402 comprises searching for a first maximum for this first sampling level.

Step 403 comprises reducing the exploration space around the maximum found in step 402 and increasing the sampling level in this reduced space with a sampling step finer than in step 401. For example, the domain of exploration is reduced by a certain percentage while still maintaining the same number of samples as in step 401 due to the reduction in the sampling step.

Steps 402 and 403 are iterated multiple times in order to refine the exact coordinates of the maximum.

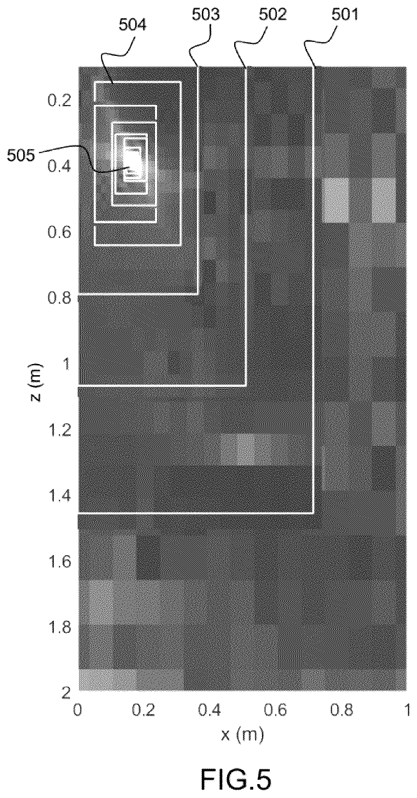

FIG. 5 illustrates one exemplary embodiment of this variant for the case of a ground-penetrating radar. The exploration space of the spatial domain is limited to the abscissa values x within a given range and the depth values z within a given range. The global estimation function is a function with three variables: xₚ, zₚ and ε′ᵣ.

FIG. 5 shows the spatial search space with successive search zones 501-504 that are reduced in each iteration so as to be centred on the maximum 505.

One drawback of this method is that it is not suitable for searching for multiple local maxima, since the iterative reduction of the search zones may exclude other local maxima.

Another variant embodiment of the invention is proposed, which makes it possible to adapt the method of FIG. 4 to the search for multiple local maxima.

This other variant consists in carrying out multiple iterations of the method of FIG. 4, each iteration being dedicated to searching for one local maximum among multiple maxima. In each iteration, the scatterer associated with the maximum detected in the previous iteration is subtracted from the observed transfer function progressively, so as to allow iterative focusing on secondary maxima of the global estimation function.

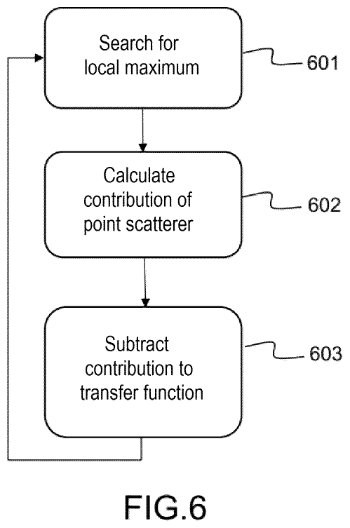

FIG. 6 shows a flowchart detailing the steps for implementing this variant embodiment.

Step 601 comprises searching for a first local maximum that corresponds to the most significant scatterer. For example, step 601 is implemented by means of the iterative method described in FIG. 4 by progressively reducing the search space.

Step 602 comprises calculating the contribution of the 1^{st} scatterer detected in step 601 to the spectral transfer function, for each pair of antennas.

With continuing reference to the example of FIG. 5, for which a limit is drawn at a spatial search space in x and z, the parameters {x₁, z₁ and ε′ᵣ₁} of the first point scatterer are obtained in step 601.

An estimator of the complex backscatter coefficient of the first point scatterer is then calculated, this being given for example by Relationship (6):

$$= \frac{1}{MN} {\sum }_{m = 1}^{M} {\sum }_{n = 1}^{N} {ℒ}_{mn} ( {f}_{l} , {x}_{1} , {z}_{1} , {ε}_{r 1}^{′} ) \qquad ( 6 )$$

As an alternative, considering that the backscatter coefficient is not frequency-dependent, Relationship (6) is replaced by Relationship (6′):

$$= \frac{1}{M N} {\sum }_{m = 1}^{M} {\sum }_{n = 1}^{N} {\sum }_{l = 1}^{L} {ℒ}_{m n} ( {f}_{l} , {x}_{1} , {z}_{1} , {ε}_{r 1}^{′} ) \qquad ( 6 )$$

Next, the contribution of the first scatterer to the spectral transfer function is calculated by means of Relationship (7) by multiplying the backscatter coefficient and the model taken at the values of the first extremum:

$${H}_{m n}^{1} ( {f}_{l} ) = \cdot {W}_{m n} ( {f}_{l} , {x}_{1} , {z}_{1} , {ε}_{r 1}^{′} ) \qquad ( 7 )$$

Next, step 603 comprises subtracting the contribution calculated in step 602 to the transfer function initially measured in step 101 so as to obtain a residual transfer function in which the contribution of the first scatterer has been removed:

$${H}_{m n}^{r e s 1} ( {f}_{l} ) = {H}_{m n} ( {f}_{l} ) - {H}_{m n}^{1} ( {f}_{l} ) \qquad ( 8 )$$

Steps 601, 602, 603 are then iterated as many times as there are local maxima to be detected by subtracting, in each iteration, the contribution of the detected scatterer to the transfer function.

A stop criterion for the method is for example a predefined number of iterations or a criterion for comparing the power ratio between the residual transfer function and the transfer function initially measured to a predefined threshold.

In one variant embodiment that is applicable notably to ground-penetrating radars, the global estimation function [symbol] (x_{P}, z_{P}, ε′ᵣ) is modified so as to introduce a change of variable. Specifically, to facilitate the search for maxima in a multidimensional space, it is appropriate to modify the depth variable z by replacing it with an electrical depth variable zₑₗ=z·\sqrt{ε′ᵣ}.

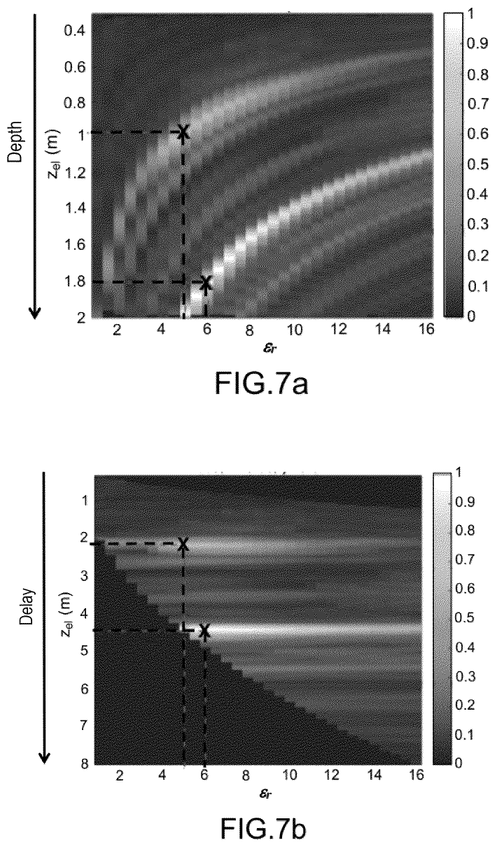

FIGS. 7a and 7b illustrate, for one example, the advantage of such a change of variable.

FIG. 7a shows the value of the function [symbol] (xₚ, zₚ, ε′ᵣ) represented by its maximum value along dimension x in the plane (ε′ᵣ, Z).

FIG. 7b shows the same value in the plane (ε′ᵣ, zₑₗ).

It may be noted that the focusing task is clearly better defined in the plane (ε′ᵣ, zₑₗ). This is due to the fact that the physical metric that is analysed is fundamentally temporal in nature because it is equivalent to a delay and not spatial in nature. A better quantified function is thus obtained when a regular grid is observed in the plane (ε′ᵣ, zₑₗ), with respect to the plane (ε′ᵣ, Z).

FIGS. 7a and 7b show two maxima for the values (ε′ᵣ, zₑₗ)=(5, 2.10 m) and (6, 4.50 m).

In another variant embodiment of the invention, Dix's formula, which is described in reference [8], is used to estimate the average permittivities of a plurality of layers of ground.

Picking up on the example of FIGS. 7a and 7b, the search for maxima enabled two objects to be detected: one at a depth of 0.95 m with an average permittivity of 5 and the other at a depth of 1.80 m with an average permittivity of 6. Specifically, the average values of the permittivities correspond to the portion of the ground between the antenna array and the scatterer associated with the detected maximum.

The double detection identified in FIGS. 7a and 7b thus makes it possible to observe the existence of at least two layers of materials of different permittivities. To obtain the permittivity per layer from the average permittivity, Dix's formula, which is based on root-mean-square velocities, is applied. This method makes it possible to decompose the average permittivities into permittivities per layer.

Thus, the permittivity ε_{r[c}_{ₙ}_{]} of layer Cₙ is determined from the average permittivities E_{r[c}_{_{0→n}}_{]} between the antenna array and layer Cₙ and between the antenna array and layer Cₙ₋₁ ε_{r[c0→n-1]}, by means of the following relationships:

$${ε}_{r [ {c}_{n} ]} = {( \frac{{z}_{n} \sqrt{{ε}_{r [ {c}_{0 \to n} ]}} - {z}_{n - 1} \sqrt{{ε}_{r [ {c}_{0 \to n - 1} ]}}}{{z}_{n} - {z}_{n - 1}} )}^{2}$$

$${ε}_{r [ {c}_{0 \to 0} ] = 1}$$

$${z}_{0} = 0$$

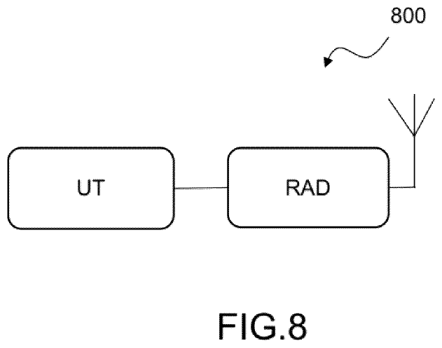

FIG. 8 schematically shows a system 800 for determining electromagnetic properties of a medium according to one embodiment of the invention.

The system 800 mainly comprises a radio-frequency detection device RAD of the type illustrated in FIG. 2 and a processing unit UT configured to implement the method according to the invention on the basis of measurements made by the device RAD.

The processing unit UT may take the form of software and/or hardware, and notably employ one or more processors and one or more memories. The processor may be a generic processor, a specific processor, an application-specific integrated circuit (ASIC) or a field-programmable gate array (FPGA).

The system 800 may comprise a user interface for displaying results produced by the method.

### REFERENCES

[0142][1]S. Serkan and V. Borecky, “Estimation methods for obtaining GPR signal velocity,” in Proceedings of the Third International Conference on ACSEE, Zurich, Switzerland, 2015, pp. 10-11.
[0143][2]E. Forte and M. Pipan, “Review of multi-offset GPR applications: Data acquisition, processing and analysis,” Signal processing, vol. 132, pp. 210-220, 2017.
[0144][3]I. Dal Bo, A. Klotzsche et al., “Geophysical imaging of regolith in landscapes along a climate and vegetation gradient in the Chilean coastal cordillera,” Catena, vol. 180, pp. 146-159, 2019.
[0145][4]Q. Dou, L. Wei, D. R. Magee, and A. G. Cohn, “Real-time hyperbola recognition and fitting in GPR data,” IEEE Transactions on Geoscience and Remote Sensing, vol. 55, no. 1, pp. 51-62, 2017.
[0146][5]C. Ozdemir, S,. Demirci et al., “A review on migration methods in B-scan ground penetrating radar imaging,” Mathematical Problems in Engineering, vol. 2014, 2014.
[0147][6]Z. Dong, X. Feng et al., “3D migration depth focus velocity analysis of hand-held ground penetrating radar,” Geosciences, vol. 12, no. 4, p. 178, 2022.
[0148][7]E. F. Knott, J. F. Schaeffer, and M. T. Tulley, Radar Cross Section. SciTech Publishing, 2004.
[0149][8]C. H. Dix, “Seismic velocities from surface measurements,” Geophysics, vol. 20, no. 1, pp. 68-86,1955.
[0150][9] Demery, D. A., J. D. Parsons, and A. M. D. Turkmani. “Sounding techniques for wideband mobile radio channels: a review.” IEEE Proceedings (Communications, Speech and Vision) 138.5 (1991): 437-446.
[0151][10] Laurenson, Dave, and Peter Grant. “A review of radio channel sounding techniques.” 2006 14th European Signal Processing Conference. IEEE, 2006.
[0152][11] Ullah, M. Habib, and A. Unggul Priantoro. “A review on multiplexing schemes for MIMO channel sounding.” International Journal of Computer Science and Network Security 9.6 (2009): 294-300.

1. A computer-implemented method for determining electromagnetic properties of a medium, comprising steps of:
determining, by means of a radio-frequency detection system comprising at least one transmitter and one receiver, for each pair associating one receiver and one transmitter, a measurement of a frequency transfer function of a transmission channel characterizing said medium,
determining, for each of said pairs, a model of said frequency transfer function dependent on at least one positional variable and on at least one variable characterizing an electromagnetic property of the medium,
determining, for each of said pairs, a correlation coefficient between the measurement of the frequency transfer function and the model,
determining a global estimation function estimating the correlation coefficient between the transfer function measurements and the models, for all pairs,
searching for at least one local maximum of the estimation function in the domain defined by the at least one positional variable and the at least one variable characterizing an electromagnetic property of the medium,
deducing therefrom at least one value of the variable characterizing the electromagnetic property of the medium as the one that makes it possible to obtain said local maximum.

2. The method for determining electromagnetic properties of a medium according to claim 1, wherein the step of searching for at least one local maximum of the estimation function is carried out by means of multiple iterations of substeps of:
defining a first sampling level of the search space,
searching for a local maximum for this first sampling level,
reducing the search space around the local maximum and defining a second sampling level in the reduced search space, the step of the second sampling level being finer than the step of the first sampling level.

3. The method for determining electromagnetic properties of a medium according to claim 1, wherein the step of searching for at least one local maximum of the estimation function comprises substeps of:
searching for a first local maximum of the estimation function,
determining the backscatter coefficient of the first scatterer associated with the first local maximum from said local maximum of the global estimation function,
determining the contribution of the first scatterer to the measurement of the frequency transfer function as equal to the product of the backscatter coefficient of the first scatterer and the value of the transfer function model taken at the coordinates of the first local maximum,
subtracting the contribution of the first scatterer from the measurement of the frequency transfer function,
iterating the preceding steps to search for another local maximum of the global estimation function determined from the corrected measurement of the frequency transfer function.

4. The method for determining electromagnetic properties of a medium according to claim 1, wherein the at least one variable characterizing an electromagnetic property of the medium is selected from: the real part or imaginary part of the dielectric permittivity or permeability.

5. The method for determining electromagnetic properties of a medium according to claim 1, comprising searching for multiple local maxima of the estimation function, each local maximum providing a position value for a scatterer of the medium and a value of the variable characterizing the electromagnetic property at said position.

6. The method for determining electromagnetic properties of a medium according to claim 1, wherein the correlation coefficient is determined using a ZF, MMSE or MRC equalization method.

7. The method for determining electromagnetic properties of a medium according to claim 1, wherein the global estimation function estimating the correlation coefficient is determined as an average of the correlation coefficients for all the pairs and for one or more discrete frequency values.

8. The method for determining electromagnetic properties of a medium according to claim 7, wherein each correlation coefficient is weighted by a predefined weighting coefficient.

9. The method for determining electromagnetic properties of a medium according to claim 1, wherein the at least one positional variable is a depth value and the method comprises a step of replacing, in the global estimation function, the depth variable with an electrical depth variable zₑₗ=z·\sqrt{Eᵣ′}, where ε′ᵣ is the real part of the dielectric permittivity.

10. A system for determining electromagnetic properties of a medium comprising a radio-frequency detection device comprising at least one transmitter and one receiver and a processing unit, the system being configured to implement the method according to claim 1.

11. The system according to claim 10, wherein the radio-frequency detection device is a ground-penetrating radar.

12. A computer program comprising code instructions that cause a system, for determining electromagnetic properties of a medium comprising a radio-frequency detection device comprising at least one transmitter and one receiver and a processing unit, to execute the method according to claim 1.

13. A computer-readable medium on which the computer program according to claim 12 is stored.
